(19) United States
(12) Patent Application Publication
(10) Pub. No.: US 2024/0144172 A1
(43) Pub. Date: May 2, 2024

(54) PREDICTING SHELF LIFE OF PERISHABLE FOOD IN AN ONLINE CONCIERGE SYSTEM

(71) Applicant: Maplebear Inc. (dba Instacart), San Francisco, CA (US)

(72) Inventors: Apurvaa Subramanian, Renton, WA (US); Girija Narlikar, Palo Alto, CA (US); Chakshu Ahuja, San Jose, CA (US); Karuna Ahuja, San Francisco, CA (US); Radhika Goel, San Francisco, CA (US); Sneha Chandrababu, Sammamish, WA (US)

(21) Appl. No.: 17/977,724

(22) Filed: Oct. 31, 2022

(51) Int. Cl. G06Q 10/08; G06Q 30/02; G06Q 30/06

(52) U.S. Cl. CPC G06Q 10/087; G06Q 10/083; G06Q 30/0206; G06Q 30/0635

(57) ABSTRACT

An online concierge system facilitates a concierge service for ordering, procurement, and delivery of food items from physical retailers. The order fulfillment is based in part on automatically inferring one or more quality metrics, such as remaining shelf-life, associated with perishable food items. A picker shopping on behalf of a customer may capture images of available food items for the order using a picker client device. The images are processed through a machine learning model to infer the one or more quality metrics, and a price is then determined based in part on a dynamic pricing model. The online concierge system communicates with a customer client device to meet quality characteristics and pricing preferences set by the customer. The online concierge system may further facilitate a checkout process for the items obtained by the picker and may facilitate delivery of the items by the picker to the customer.

### BACKGROUND

In an online concierge system, a customer may place an order for one or more items available at a physical retailer for procurement and delivery by an assigned picker that shops on behalf of the customer. For orders containing perishable food items, a retailer may have a wide range of items available that have differing remaining shelf-lives or other quality characteristics. A challenge can therefore exist for the picker in selecting the specific perishable items for fulfilling an order that will best meet the customer's preferences.

### SUMMARY

In accordance with one or more aspects of the disclosure, an online concierge system facilitates a concierge service for ordering, procurement, and delivery of food items from physical retailers based in part on automatically determining one or more quality metrics (such as remaining shelf-life) associated with perishable food items. In an example process, the online concierge system obtains an order for one or more items for procurement from a retailer and delivery by a picker to a customer. The online concierge system obtains, from an imaging system of mobile device operated by the picker assigned to the order, an image of a perishable food item at the retail location associated with the one or more items in the order. The online concierge system applies a machine learning model to the image to generate one or more quality metrics for the food item. For example, the machine learning model may infer a remaining shelf-life and/or other quality characteristics of food items available at the retail location. The online concierge system furthermore applies based on the one or more quality metrics, a dynamic pricing model to determine a price for the food item. The online concierge system electronically facilitates a checkout process for the order in part by applying the price to the food item. Following the checkout process, the online concierge system facilitates, via the picker client device, delivery of the one or more items in the order to the customer.

In one or more embodiments, obtaining the order for the customer may include obtaining a customer preference associated with at least one of the quality metrics or the price for the food item, and providing instructions to the shopper via the mobile application to select the perishable food item according to the customer preference.

In one or more embodiments, prior to facilitating the checkout process, the online concierge system may send to a customer client device, information describing the one or more quality metrics inferred by the machine learning model and the price for the food item set by the dynamic pricing model. In response, the online concierge system may receive a selection from the customer client device for the perishable food item having the desired quality characteristic and price selected from among a plurality of selectable perishable food items having different quality metrics or prices.

In one or more embodiments, the online concierge system may furthermore generate a plurality of predicted quality metrics and corresponding prices for a plurality of food items, generate an augmented reality view that overlays at least one of the predicted quality metrics and corresponding prices on a real-time image or video depicting the plurality of food items, and present the augmented reality view in a picker client device.

In one or more further embodiments, the online concierge system may send the augmented reality view for presentation via a customer client device. A selection of the perishable food item (with the desired quality characteristics and/or price) may be received from the customer client device via a control element displayed in the augmented reality view.

In one or more further embodiments, applying the machine learning model comprises obtaining one or more inputs via the picker client device describing an observed quality characteristic of the perishable food item, and generating the one or more quality metrics based at least in part on the one or more inputs.

In one or more further embodiments, applying the machine learning model comprises obtaining one or more inputs from an inventory management system relating to at least one of: a shipping date of the perishable food item, an arrival date of the perishable food item, a stocking date of the perishable food item, and a planned restocking date of the perishable food item. The one or more quality metrics may then be generated based at least in part on the one or more inputs from the inventory management system.

In one or more embodiments, the online concierge system may obtain feedback via the customer mobile application indicative of an accuracy of the inferred quality metrics following delivery of the one or more items. The machine learning model may then be updated based on the feedback.

In one or more embodiments, applying the dynamic pricing model comprises obtaining a predicted demand for the perishable food item, and determining the price based at least in part on the predicted demand.

In one or more further embodiments, a non-transitory computer-readable storage medium stores instructions executable by a processor for carrying out the methods described herein.

In one or more further embodiments, a computer system includes a processor and a non-transitory computer-readable storage medium that stores instructions executable by the processor for carrying out the methods described herein.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart illustrating an example embodiment of a process for facilitating ordering, procurement, and delivery of an order containing perishable food items.

FIG. 4 is an example or an augmented reality view of a retail environment that depicts predicted quality scores and dynamic pricing associated with perishable food items.

### DETAILED DESCRIPTION

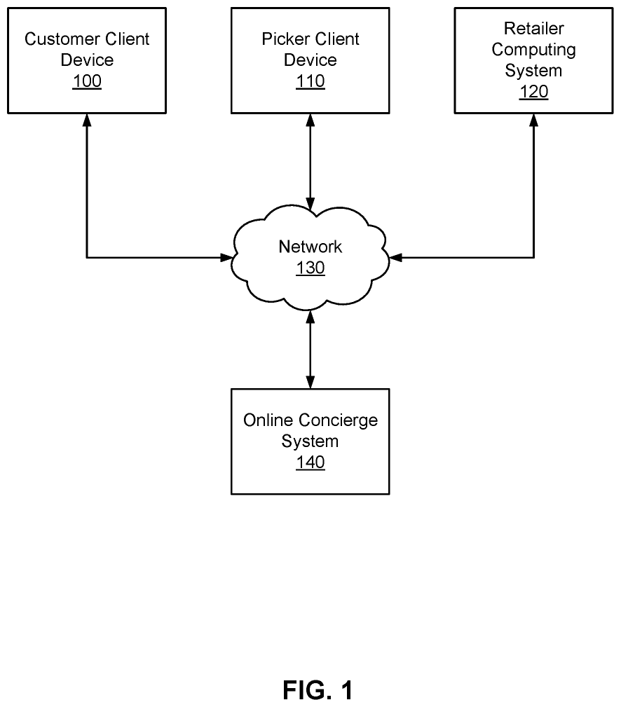

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. The order may furthermore include information for selecting between perishable food items based on a quality score representing remaining shelf-life or other quality factor for the items, as will be described in further detail below. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item. As will be described in further detail below, the picker client device 110 can furthermore provide tools to help the picker select between available perishable food items (e.g., produce, bakery products, meats, seafood, etc.) to best meet criteria specified in the order.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

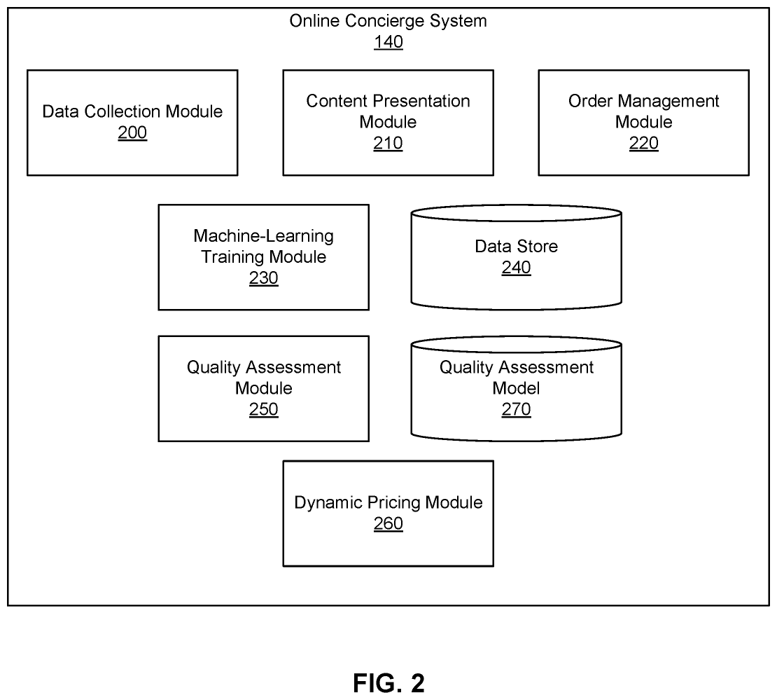

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, a data store 240, a quality assessment module 250, a dynamic pricing module 260, and a quality assessment model 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm). In one or more embodiments, items of the same or similar type may be divided into different categories based on one or more quality metrics such as predicted remaining shelf-life, aesthetic characteristics, textural characteristics, and/or other quality metric.

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In one or more embodiments, the order data may specify a particular desired shelf-life and/or price associated with items as will be further described below.

The quality assessment module 250 applies a quality assessment model 270 to generate inferences characterizing quality of perishable food items based on images, videos, or other inputs provided in the retail environment via the picker client device 110 or obtained from an inventory management system of the retailer. The inferences may comprise, for example, a quality score relating to predicted remaining shelf life (e.g., number of days), aesthetic characteristics, textural characteristics, or other quality metrics associated with perishable food items.

The quality assessment model 270 may comprise, for example, a supervised machine learning model trained to learn relationships between input vectors including images and/or videos of food items and/or other descriptive data and labels characterizing one or more quality attributes such as the expected remaining shelf-life of a perishable food item. For training purposes, the labels may be obtained from annotation of images (or other input data) from industry experts, or may be gathered based on feedback from customers or pickers. The shelf-life of a particular food item may be defined by the time until a “use by” date, a “best by” date, or some other metric describing longevity of perishable food items. The end of the shelf-life may be based on various food industry standards for evaluating food quality and safety (such as those set forth by the Food and Drug Administration or other food regulators). Alternatively, the end of shelf-life may be based on other customized food quality and/or safety assessments that do not necessarily align with those specified by food regulators. For example, the end of shelf-life may be based on a retailer-specific policy for when to discard unsold food items. Policies and standards for determining the shelf-life of a food item may be based on various quantitative metrics, qualitative metrics, or a combination thereof. Quantitative metrics may include, for example, the number of days since the food item was harvested or manufactured, the number of items the food item has been stored, the number of days since the food item arrived at the retailer or a shipping facility, the number of days the food item has been on the shelf, or other criteria. Qualitative metrics used to establish a food item's shelf life may relate to factors such as coloration, firmness, texture, smell, taste, or other factors used to standardize the assessment of a food item's remaining shelf life.

The labels may alternatively relate to other quality metrics that are not necessarily directly related to shelf-life. For example, the labels may relate to visual characterization (e.g., size, color, shape, etc.), tactile characterizations (e.g., texture, firmness, soft spots, etc.), smell, taste, or other qualities that can be assessed relative to industry or retailer-defined standards for different types of food items. In one or more embodiments, multiple types of quality measures may be combined (e.g., as a linear or non-linear combination) to generate a label representing a combined quality score for the food item that could be based on multiple different quality factors.

In an inference phase, the quality assessment module 250 may receive an image (or video) of a food item (and/or other input) and apply the quality assessment model 270 to infer the remaining shelf-life and/or other quality characteristics according to the standards learned in the training phase. In some embodiments, the quality assessment module 250 may generate the inferences based on multiple different types of inputs in addition to image or video input. For example, the quality assessment module 250 may receive text inputs from the picker client device 110 describing food quality observed by the picker and inputted into the device 110 (e.g., in response to survey questions). Additionally, in some embodiments, the inferences may be based in part on information obtained from an inventory management system of the retailer such as, for example, information about when the food was harvested, shipped, put on the shelf, targeted for restocking, or general quality observations entered by agents of the retailer.

In one or more embodiments, the machine learning training module 230 may retrain the quality assessment model 270 in an online manner based on feedback received from customers and/or pickers. For example, after receiving food items, customers may provide feedback indicating an observed shelf-life, or other quality and/or satisfaction rating associated with the received food items. Furthermore, pickers may manually input quality ratings associated with captured images of food items that may serve as additional labels. This feedback may be applied as new labels associated with the original image or other input data for the food item to improve the predictive power of the quality assessment model 270.

The dynamic pricing module 260 may dynamically set a price of a food item based in part on one or more quality metrics generated by the quality assessment module 250. For example, in some instances, the dynamic pricing module 260 may cause the price of an item to decrease as the predicted remaining shelf-life or other quality characteristic decreases. Alternatively, the dynamic pricing module 260 may decrease the price when the predicted remaining shelf-life falls outside an ideal range indicative of food that may be overripe or underripe. In one or more embodiments, the dynamic pricing module 260 may perform a lookup in a lookup table that maps specific food items and inferred quality metric(s) to a predefined price. Alternatively, a function may be applied to a base price for the food item with one or more quality metrics used as a parameter of the function. For example, the function may set the price as a percentage of the base price where the percentage decreases with decreased quality. The specific pricing model may be obtained from the retailer computing system 120 so that different retailers can control pricing of items in different ways.

In one or more embodiments, the dynamic pricing module 260 may be integrated with other aspects of the online concierge system 140 to set the price for a food item based on multiple dynamic factors in combination with the predicted quality metrics. For example, the dynamic pricing module 260 may set the price based in part on additional factors such as, the location of the retailer, the time of day, a scarcity metric associated with the food item, characteristics of the customer, or various factors associated with supply and demand for the food item.

In one or more embodiments, the dynamic pricing module 260 may incorporate predictions about demand for a particular item into the pricing decision. For example, the dynamic pricing module 260 may include a machine-learning model that predicts demand for an item on a given day and may offer discounts for items that are not predicted to be in sufficient demand prior to their predicted expirations. Here, the dynamic pricing module 260 may further set pricing in a way that optimizes profitability or other business metrics based on the inferences from the various machine learning models.

In one or more embodiments, the dynamic pricing module 260 may be configured based at least in part on inputs from a source of the food items. For example, the source may configure discounting preferences associated with discounted prices that are passed to the food source rather than being fully absorbed by the retailer.

In one or more embodiments, the dynamic pricing module 260 may be applied only after the picker arrives at the retailer and captures images of specific food items. Here, a customer may place an order using a base price, and then later be offered a discount (via the customer client device 100) to accept lower quality food items and/or to pay a premium for higher quality food items dependent on what is available when the picker is shopping. The customer can then choose whether or not to accept an offer based on dynamic pricing by making a selection via the customer client device 100. In other embodiments, customers may be able to request specific expected shelf-lives or other quality factors and corresponding pricing when the order is placed. In one or more embodiments, the range of quality metrics and pricing available when placing an order may be determined based on predictions made from historical item availability data.

The content presentation module 210 selects content for presentation to a customer via the customer client device 100. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

In one or more embodiments, the content presentation module 210 may generate promotional content for customers based at least in part on shelf-life or other quality information relating to in-store products. For example, the content presentation module 210 may present promotions for items near the end of their shelf lives (potentially at discounted prices) to encourage customers to select those items before the retailer has to discard them.

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 may present items together with predicted quality scores for the items. In one or more embodiments, the available options may be sent to the customer client device 100 after the quality assessment module 250 predicts the quality metrics for a set of items available at the retail location. The customer may then select between items meeting their desired criteria. In one or more embodiments, the content presentation module 210 may further present dynamic pricing information associated with items having different predicted quality metrics to allow the customer to select the desired combination.

In other embodiments, the content presentation module 210 enables the customer to request items meeting certain quality criteria when placing the order. Here, the customer may specify the desired quality criteria either as a requirement without allowing substitutions (i.e., the item should be removed from the order if the criteria cannot be met), or may be specified as a preference that allows for substitutions if the item meeting the requested quality criteria is unavailable. In one or more embodiments, a customer can specify a general preference instead of selecting a specific preference for each food item. For example, a customer can preset a preference to always select produce with the longest available shelf-life. In yet further embodiments, customers may preset preferences for specific food items. For example, the customer can preset a preference to buy strawberries with a shelf-life of at least one week. In yet further embodiments, default preferences may be set without the customer necessarily inputting preferences. For example, in the absence of other preferences, a picker for an order may be instructed to only select food items having at least a default shelf-life in accordance with a default threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the picker client device 110 may present inferred quality metrics and dynamic pricing information based on images and/or video of food items captured by the picker client device 110 when the picker is fulfilling an order. For example, the picker client device 110 may present shelf-life or other quality information and dynamic pricing information in an augmented reality view as information overlaid on a real-time view of the food items to enable the picker to select items matching the order. The augmented reality view could be shared with the customer client device 100 to enable the customer to select between available items having different quality characteristics and/or pricing using a control element of the augmented reality view.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The order management module 220 may furthermore facilitate communication with the customer relating to quality characteristics of items available at the retailer. For example, the picker client device 110 may capture images or video of available items that are analyzed by the quality assessment module 250 and dynamic pricing module 260 to determine predicted quality metrics and associated prices for available items. The order management module 220 may transmit the quality information and dynamic pricing information to the customer to enable the customer to select a desired combination while the picker is at the retailer. For example, the order management module 220 may transmit the augmented reality view described above to the customer client device 100 to enable the customer to directly select between food items with different quality characteristics and/or prices.

The machine learning training module 230 trains machine learning models used by the online concierge system 140. For example, the machine learning training module 230 may train the quality assessment model 270 or other machine learning models described herein. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

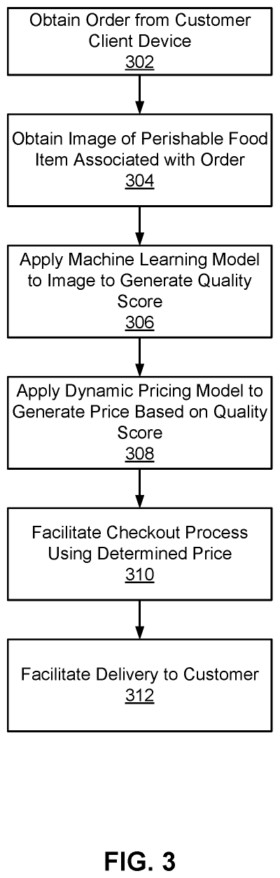

FIG. 3 illustrates an example embodiment of a process for facilitating ordering, procurement, and delivery of orders including perishable food items to a customer via an online concierge system 140. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 obtains 302 an order for one or more items via the customer client device 100. The order may include one or more perishable food items having a limited shelf-life and/or other varying quality characteristics. While facilitating procurement the order, the online concierge system 140 obtains 304 from an imaging system of the picker client device 110, an image of a perishable food item associated with one or more items in the order. The online concierge system 140 applies 306 a machine learning model to the image to generate a quality score of the perishable food item depicted in the image. Optionally, the machine learning model may infer quality based in part on other inputs provided by the picker (e.g., describing a perceived quality of the food item), information obtained from the retailer (e.g., relating to stocking information), or information from other sources that may be relevant to predicting the shelf-life or other quality characteristics of the item. The online concierge system 140 applies 308 a dynamic pricing model to generate a price for the perishable food item based in part on the inferred quality score. The pricing model may be based on a lookup table, a predefined function, or other model for generating the price. The online concierge system 140 electronically facilitates 310 a checkout process associated with the order using the price determined by the pricing model. The online concierge system 140 then facilitates 312 delivery of the one or more items in the order via the picker client device 110.

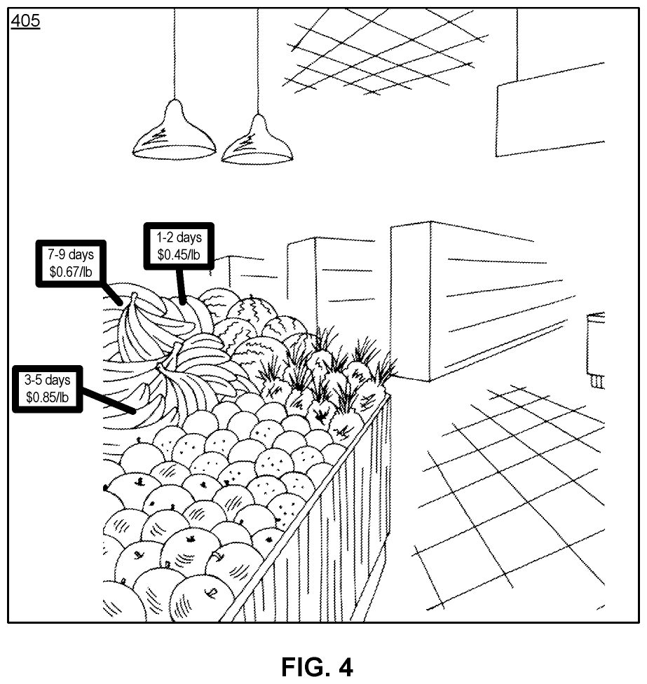

FIG. 4 illustrates an example embodiment of an augmented reality view of a retail environment that shows predicted shelf-life and dynamic pricing associated with food items. The augmented reality view 400 may be displayed in the picker client device 110 to assist the picker in fulfilling an order and/or may be sent to the customer client device 100. In this example, the customer has submitted an order including bananas. Based on images of the bananas in the retail environment obtained from the picker client device 110 the online concierge system 140 generates predicted shelf-lives for the available bananas and determines associated pricing. In the illustrated example, the online concierge system 140 identifies a first bunch of bananas with predicted shelf-lives of 3-5 days and determines a price of $0.85/lb. The online concierge system 140 identifies a second bunch of bananas with predicted shelf-lives of 1-2 days and determines a price of $0.45/lb. In this example, the dynamic pricing model assigned a lower price to the bananas closer to the end of their shelf life. The online concierge system 140 identifies a third bunch of bananas with predicted shelf-lives of 7-9 days and determines a price of $0.67/lb. In this example, the dynamic pricing model may assign a lower price to this third bunch than the first bunch because they may be considered under-ripe.

In another embodiment, the described technique may be applied to a shopping experience of a customer that is not necessarily ordered through the online concierge system 140. For example, a customer that shops directly in a retail environment may utilize a customer client device 100 to capture images of food items that are processed by the quality assessment module 250 to generate and display inferred quality characteristics of food items. Furthermore, the dynamic pricing module 260 may determine corresponding prices for items using quality metrics based on the dynamic pricing model. In one or more embodiments, the item selection and price may be provided to a checkout system to enable the customer to checkout in accordance with dynamically priced items.

### ADDITIONAL CONSIDERATIONS

The foregoing description of the embodiments has been presented for the purpose of illustration, and many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising at least one processor and a memory comprising a computer-readable medium:
obtaining, by an online concierge system, an order for one or more items for procurement and delivery, by a picker assigned to obtain the one or more items in the order, from a retailer to a customer, wherein the one or more items include a perishable food item;
obtaining, from an imaging system of a picker client device operated by the picker, an image of the perishable food item;
applying a machine learning model to the image to generate one or more quality metrics for the perishable food item;
applying, based on the one or more quality metrics, a dynamic pricing model to determine a price for the perishable food item;
electronically facilitating a checkout process for the order in part by applying the price to the perishable food item; and
following the checkout process, facilitating, via the picker client device of the picker, delivery of the one or more items in the order to the customer.

2. The method of claim 1, wherein the one or more quality metrics includes an expected remaining shelf-life of the perishable food item.

3. The method of claim 1, wherein obtaining the order comprises:
obtaining a customer preference associated with at least one of the one or more quality metrics or the price for the perishable food item; and
providing instructions to the picker via the picker client device to select the perishable food item according to the customer preference.

4. The method of claim 1, further comprising:
prior to facilitating the checkout process, sending to a customer client device, information describing the one or more quality metrics and the price for the perishable food item; and
receiving a selection from the customer client device for the perishable food item having the one or more quality metrics and the price from among a plurality of selectable perishable food items having different predicted quality metrics or prices.

5. The method of claim 1, further comprising:
generating a plurality of predicted quality metrics and corresponding prices for a plurality of food items;
generating an augmented reality view that overlays at least one of the plurality of predicted quality metrics and corresponding prices on a real-time image or video depicting the plurality of food items; and
presenting the augmented reality view in the picker client device.

6. The method of claim 5, further comprising:
sending the augmented reality view for presentation via a customer client device; and
receiving, via the customer client device, a selection of the perishable food item via a control element displayed in the augmented reality view.

7. The method of claim 1, wherein applying the machine learning model comprises:
obtaining one or more inputs via the picker client device describing a quality of the perishable food item; and
generating the one or more quality metrics based at least in part on the one or more inputs.

8. The method of claim 1, wherein applying the machine learning model comprises:
obtaining one or more inputs from an inventory management system relating to at least one of: a shipping date of the perishable food item, an arrival date of the perishable food item, a stocking date of the perishable food item, and a planned restocking date of the perishable food item; and
generating the one or more quality metrics based at least in part on the one or more inputs from the inventory management system.

9. The method of claim 1, further comprising:
following delivery of the one or more items, obtaining feedback via a customer client device indicative of an accuracy of the one or more quality metrics; and
updating the machine learning model based on the feedback.

10. The method of claim 1, wherein applying the dynamic pricing model comprises:
obtaining a predicted demand for the perishable food item; and
determining the price based at least in part on the predicted demand.

11. A non-transitory computer-readable storage medium storing instructions for execution by a processor, the instructions when executed causing the processor to perform steps including:
obtaining, by an online concierge system, an order for one or more items for procurement and delivery, by a picker assigned to obtain the one or more items in the order, from a retailer to a customer, wherein the one or more items include a perishable food item;
obtaining, from an imaging system of a picker client device operated by the picker, an image of the perishable food item;
applying a machine learning model to the image to generate one or more quality metrics for the perishable food item;
applying, based on the one or more quality metrics, a dynamic pricing model to determine a price for the perishable food item;
electronically facilitating a checkout process for the order in part by applying the price to the perishable food item; and
following the checkout process, facilitating, via the picker client device of the picker, delivery of the one or more items in the order to the customer.

12. The non-transitory computer-readable storage medium of claim 11, wherein the one or more quality metrics includes an expected remaining shelf-life of the perishable food item.

13. The non-transitory computer-readable storage medium of claim 11, wherein obtaining the order comprises:
obtaining a customer preference associated with at least one of the one or more quality metrics or the price for the perishable food item; and
providing instructions to the picker via the picker client device to select the perishable food item according to the customer preference.

14. The non-transitory computer-readable storage medium of claim 11, wherein the instructions when executed further cause the processor to perform steps including:
prior to facilitating the checkout process, sending to a customer client device, information describing the one or more quality metrics and the price for the perishable food item; and
receiving a selection from the customer client device for the perishable food item having the one or more quality metrics and the price from among a plurality of selectable perishable food items having different predicted quality metrics or prices.

15. The non-transitory computer-readable storage medium of claim 11, wherein the instructions when executed further cause the processor to perform steps including:
generating a plurality of predicted quality metrics and corresponding prices for a plurality of food items;
generating an augmented reality view that overlays at least one of the plurality of predicted quality metrics and corresponding prices on a real-time image or video depicting the plurality of food items; and
presenting the augmented reality view in the picker client device.

16. The non-transitory computer-readable storage medium of claim 15, wherein the instructions when executed further cause the processor to perform steps including:
sending the augmented reality view for presentation via a customer client device; and
receiving, via the customer client device, a selection of the perishable food item via a control element displayed in the augmented reality view.

17. The non-transitory computer-readable storage medium of claim 11, wherein applying the machine learning model comprises:
obtaining one or more inputs via the picker client device describing a quality of the perishable food item; and
generating the one or more quality metrics based at least in part on the one or more inputs.

18. The non-transitory computer-readable storage medium of claim 11, wherein applying the machine learning model comprises:
obtaining one or more inputs from an inventory management system relating to at least one of: a shipping date of the perishable food item, an arrival date of the perishable food item, a stocking date of the perishable food item, and a planned restocking date of the perishable food item; and
generating the one or more quality metrics based at least in part on the one or more inputs from the inventory management system.

19. The non-transitory computer-readable storage medium of claim 11, wherein the instructions when executed further cause the processor to perform steps including:
following delivery of the one or more items, obtaining feedback via a customer client device indicative of an accuracy of the one or more quality metrics; and
updating the machine learning model based on the feedback.

20. A computer system comprising:
a processor; and
a non-transitory computer-readable storage medium storing instructions for execution by the processor, the instructions when executed causing the processor to perform steps including:
obtaining, by an online concierge system, an order for one or more items for procurement and delivery, by a picker assigned to obtain the one or more items in the order, from a retailer to a customer,
wherein the one or more items include a perishable food item;
obtaining, from an imaging system of a picker client device operated by the picker, an image of the perishable food item;
applying a machine learning model to the image to generate one or more quality metrics for the perishable food item;
applying, based on the one or more quality metrics, a dynamic pricing model to determine a price for the perishable food item;
electronically facilitating a checkout process for the order in part by applying the price to the perishable food item; and
following the checkout process, facilitating, via the picker client device of the picker, delivery of the one or more items in the order to the customer.
